(19) United States
(12) Patent Application Publication
(10) Pub. No.: US 2022/0153629 A1
(43) Pub. Date: May 19, 2022

(54) SHEET-LIKE CHEMICALLY TOUGHENED OR CHEMICALLY TOUGHENABLE GLASS ARTICLE AND METHOD FOR PRODUCING SAME

(71) Applicant: SCHOTT AG, Mainz (DE)

(72) Inventors: Inge BURGER, Oestrich-Winkel (DE); Thomas SEUTHE, Jena (DE); Jochen ALKEMPER, Klein-Winternheim (DE); Susanne KRÜGER, Mainz (DE); Oliver HOCHREIN, Mainz (DE); Rüdiger DIETRICH, Jena (DE); Jovana DJORDJEVIC-REISS, Mainz (DE); Thomas SCHMIADY, Jena (DE); Jörg HESSENKEMPER, Jena (DE); Sebastian LEUKEL, Mainz (DE); Julia WEISSHUHN, Mainz (DE)

(73) Assignee: SCHOTT AG, Mainz (DE)

(21) Appl. No.: 17/592,541

(22) Filed: Feb. 4, 2022

Related U.S. Application Data
(63) Continuation of application No. PCT/EP2020/071965, filed on Aug. 5, 2020.

(30) Foreign Application Priority Data
Aug. 5, 2019 (DE) 10 2019 121 143.3
Aug. 5, 2019 (DE) 10 2019 121 144.1
Aug. 5, 2019 (DE) 10 2019 121 146.8
Aug. 5, 2019 (DE) 10 2019 121 147.6

(51) Int. Cl. C03C 3/091; C03C 21/00; C03C 3/097; C03C 4/18

(52) U.S. Cl. CPC C03C 3/091; C03C 21/002; C03C 2204/00; C03C 4/18; C03C 3/097

(57) ABSTRACT

A chemically toughened or chemically toughenable sheet-like glass article is provided. The glass article includes a glass with a composition having Al₂O₃, SiO₂, Li₂O, and B₂O₃. The glass and/or the glass article includes not more than 7 w t% of B₂O₃.

### CROSS REFERENCE TO RELATED APPLICATIONS

This application is a continuation of International Application PCT/EP2020/071965 filed Aug. 5, 2020, which claims the benefit under 35 USC X119 of German Application No. 10 2019 121 143.3 filed Aug. 5, 2019, German Application No. 10 2019 121 144.1 filed Aug. 5, 2019, German Application No. 10 2019 121 146.8 filed Aug. 5, 2019, and German Application No. 10 2019 121 147.6 filed Aug. 5, 2019, the entire contents of all of which are incorporated herein by reference.

### BACKGROUND

### 1. Field of the Invention

The invention relates to a sheet-like chemically toughened or at least chemically toughenable glass article and to a method for producing it. Furthermore, the present disclosure also relates to a glass composition.

### 2. Description of Related Art

Sheet-like toughened, in particular chemically toughened and in particular chemically highly toughened glass articles are used in particular as so-called protective glasses (or covers or cover glasses) for mobile devices such as smartphones or tablet computers. Compared with covers made of transparent plastics materials, these protective glasses are in particular more scratch-resistant, but they are also heavier.

Only sheet-like glass articles that have been chemically toughened are used as protective glasses for mobile devices. This is because these glass articles are even more resistant to mechanical wear and tear, i.e. they exhibit the wear resistance required for this application case. In the context of the present disclosure, wear resistance is understood to mean the resistance of a product (or article such as a glass article or a glass product) to mechanical loads, in particular to abrasive loads, scratching loads, or impact loads. Therefore, in the context of the present disclosure, the terms of “wear resistance” or “resistance” or “strength”, for short, are used generically for the mechanical resistance of a product or article. Special forms of wear resistance, or resistance or strength, for short, are scratch resistance, flexural strength, impact resistance, or preferably also hardness, for example, although it has been found that especially combinations of such stresses are possible and are of particular relevance in practical use. Such real-life stresses include the impact on a rough surface, for example, in particular in an assembled state.

In addition to the requirements for good wear resistance, the sheet-like glass article should also meet further requirements. In particular, the glass of which the glass article is made should be easy to manufacture, that is to say it should be accessible to a melting process with a subsequent hot-forming process, for example, in which devitrification should preferably not occur. The chemical resistance of the glass article is also relevant, in particular acid resistance. This should in particular be considered against the background that, while good resistance of the end product is necessary, good capability of being toughened, i.e. toughenability, must also be given in an ion exchange process, on the other hand. It has been found that good toughenability in an ion exchange process in general rather correlates with low chemical resistance, because the high mobility, particularly of alkali ions, which is advantageous for easy ion exchange, tends to be detrimental to chemical resistance.

Known chemically toughenable glasses and/or chemically toughenable or chemically toughened glass articles and/or processes for producing such articles have been described in the patent family of US 2019/0016632 A1, for example, including U.S. patent U.S. Pat. No. 9,593,42 B2 as an already granted family member; in the patent family of US 2018/0057401 A1 including U.S. Pat. No. 10,294,151 B2 as an already granted family member; in the patent family of US 2018/0029932 A1 including U.S. Pat. No. 10,259,746 B2 as an already granted family member; in the patent family of US 2017/0166478 Al including U.S. Pat. No. 9,908,811 B2 as an already granted family member; U.S. Pat. No. 9,908,811 B2; in the patent family of US 2016/0122240 A1 including U.S. Pat. No. 10,239,784 B2 as an already granted family member; in the patent family of US 2016/0122239 Al including U.S. Pat. No. 10,150,698 B2 as an already granted family member; in the patent family of US 2017/0295657 A1 including U.S. Pat. No. 10,271,442 B2 as an already granted family member; in the patent family of US 2010/0028607 Al including U.S. Pat. No. 8,312,739 B2 as an already granted family member; in the patent family of US 2013/0224492 A1 including U.S. Pat. No. 9,359,251 B2 as an already granted family member; in the patent family of US 2016/0023944 A1 including U.S. Pat. No. 9,718,727 B2 as an already granted family member; in the patent family of US 2012/0052271 A1 including U.S. Pat. No. 10,227,253 B2 as an already granted family member; in the patent family of US 2015/0030840 A1 including U.S. Pat. No. 10,227,253 B2 as an already granted family member; in the patent family of US 2014/0345325 A1, in the patent family of US 2016/0257605 A1 including U.S. Pat. No. 9,487,434 B2 as an already granted family member; in the patent family of US 2015/0239776 A1 including U.S. Pat. No. 9,517,968 B2 as an already granted family member; in the patent family of US 2015/0259244 A1 including U.S. Pat. No. 9,567,254 B2 as an already granted family member; in the patent family of US 2017/0036952 A1 including U.S. Pat. No. 9,676,663 B2 as an already granted family member; in the patent family of US 2018/0002223 A1 including U.S. Pat. No. 10,266,447 B2 as an already granted family member; in the patent family of US 2017/0129803 A1 including U.S. Pat. No. 9,517,968 B2 as an already granted family member; in the patent family of US 2016/0102014 A1 including U.S. Pat. No. 10,266,447 B2 as an already granted family member; in the patent family of US 2015/0368153 A1 including U.S. Pat. No. 9,676,663 B2 as an already granted family member; in the patent family of US 2015/0368148 A1 including U.S. Pat. No. 9,902,648 B2 as an already granted family member; in the patent family of US 2015/0239775 A1 including U.S. Pat. No. 10,118,858 B2 as an already granted family member; in the patent family of US 2016/0264452 A1 including already granted U.S. patent U.S. Pat. No. 9,902,648 B2; in the patent family of US 2016/102011 A1 and already granted U.S. Pat. No. 9,593,042 B2; in the patent family of WO 2012/126394 A1; in the patent family of US 2014/0308526 A1 and the already granted U.S. Pat. No. 9,540,278 B2; in the patent family of US 2011/0294648 A1 and the already granted U.S. Pat. No. 8,759,238 B2; in the patent family of US 2010/0035038 A1 and the already granted U.S. Pat. No. 8,075,999 B2; in the patent family of U.S. Pat. No. 4,055,703; in the patent family of DE 10 2010 009 584 A1, granted German patent DE 10 2010 009 584 B4, and the U.S. application US 2016/0347655 A1 including the already granted U.S. Pat. No. 10,351,471 B2; in the patent family of CN 102690059 A and the already granted Chinese patent CN 102690059 B; in the patent family of US 2016/0356760 A1 and the already granted U.S. Pat. No. 10,180,416 B2; in the patent family of WO 2017/049028 Al including U.S. Pat. No. 9,897,574 B2 as an already granted family member; in the patent family of WO 2017/087742 A1; in the patent family of US 2017/0291849 A1 and the already granted U.S. Pat. No. 10,017,417 B2; in the patent family of US 2017/0022093 A1 and the already granted U.S. Pat. No. 9,701,569 B2; in the patent family of US 2017/300088 A1 and granted U.S. Pat. No. 9,977,470 B2; in the patent family of EP 1 593 658 A1, granted European patent EP 1 593 658 B1, and U.S. application US 2005/0250639 A1; and in the patent family of US 2018/0022638 A1 and the already granted U.S. Pat. No. 10,183,887 B2. Here, chemically toughenable glasses can be differentiated into so-called aluminum silicate glasses (also referred to as AS glasses, alumosilicate glasses or aluminosilicate glasses) which in particular include Al₂O₃ and SiO₂ as well as alkali oxides other than lithium oxide Li₂O as constituents, and lithium aluminum silicate glasses (also referred to as LAS glasses, lithium alumosilicate glasses or lithium aluminosilicate glasses), which additionally contain Li₂O as a constituent.

Further prior art documents that can be found include the patent family of US 2019/0152838 A1; the patent family of US 2013/0122284 A1 and the already granted U.S. Pat. No. 9,156,724 B2; the patent family of US 2015/0079400 A1 including the already granted U.S. intellectual property right U.S. Pat. No. 9,714,188 B2; the patent family of US 2015/0099124 A1 and the already granted U.S. Pat. No. 9,701,574 B2; the patent family of WO 2019/085422 A1; the patent family of US 2017/0197869 A1 and the already granted U.S. Pat. No. 10,131,567 B2; the patent family of US 2015/0030840 A1 and the already granted U.S. intellectual property right U.S. Pat. No. 10,227,253 B2; the patent family of US 2015/0140325 A1 and the already granted U.S. intellectual property right U.S. Pat. No. 10,125,044 B2; the patent family of US 2015/0118497 A1 and the already granted U.S. intellectual property right U.S. Pat. No. 9,822,032 B2; the intellectual property right family of US 2012/0135852 A1 and the already granted U.S. intellectual property right U.S. Pat. No. 8,796,165 B2; the intellectual property right family of US 2015/0147575 A1 and the already granted U.S. Pat. No. 10,000,410 B2; and the intellectual property right family of US 2015/0376050 A1 and the already granted U.S. Pat. No. 9,783,451 B2.

These glasses are designed so as to be capable of being chemically toughened. In the context of the present disclosure, a glass that can be chemically toughened is understood to mean a glass which is accessible to an ion exchange process. Such a process involves an exchange of alkali metal ion in a surface layer of a glass article such as a glass sheet. This is executed in such a way that a compressive stress zone is established in the surface layer, which is achieved by exchanging ions with smaller radii by ions having larger radii. For this purpose, the glass article is immersed in a so-called ion exchange bath, for example a molten salt, the ion exchange bath comprising the ions having the larger ionic radii, in particular potassium and/or sodium ions, so that the latter migrate into the surface layer of the glass article. In exchange, ions with smaller ionic radii, will migrate out of the surface layer of the glass article and into the ion exchange bath, in particular sodium and/or lithium ions.

This creates a compressive stress zone which can be described by the characteristic values of compressive stress, or “CS”, for short, and the depth of the compressive stress which is also referred to as “Depth of Layer”, or “DoL”, for short. This depth of layer, DoL, is well known to the person skilled in the art and, in the context of the present disclosure, indicates the depth at which the stress curve passes through zero stress. For glasses of the LAS type and of the LABS type, which are accessible to a mixed exchange process, a distinction is made between two different depths of layer, the potassium DoL which describes the depth of the potassium-induced compressive stress, and the sodium DoL which in some cases is also abbreviated as DoCL (depth of compression layer). This sodium DoL describes the depth of the sodium-induced compressive stress. Alternatively or additionally, this thickness DoL can be determined by a stress-optical zero crossing measurement method, for example using a measuring device with the trade name FSM-6000 or SLP 1000. These measurement techniques are based on different physical methods. The FSM measuring device measures the potassium parameters (K-DoL and CS(0)), SLP measures the sodium parameters CS(30) and DoCL.

The measuring device FSM-6000 can also be used for aluminosilicate glasses for determining the surface compressive stress and the maximum compressive stress CS of a sheet or a sheet-like glass article.

In the context of the present disclosure, unless explicitly stated otherwise, the terms of wear resistance and strength are used largely synonymously as a generic term for the resistance of a material or a product to mechanical attack. In the context of the present disclosure, special strengths, for example the set drop strength or flexural strength (also: flexural tensile strength) are understood as subcases of the (overall) strength of a material or product or article. Also, in the context of the present disclosure, the hardness of a material is generically subtotaled under the term wear resistance. In the context of the present disclosure, hardness is understood to mean the mechanical resistance which a material or a product, for example a sheet-like glass article, opposes to the penetration of another object. The hardness value determined for a material or a product also depends on the exact type of hardness test carried out, inter alia. Well-known hardness parameters are the Mohs hardness or the Vickers hardness, for example, the Mohs hardness being a no longer common technique of determining hardness. Rather, Knoop hardness is often specified. However, Mohs hardness and Knoop hardness are unfavorable hardness determination techniques for glasses and glass ceramics, since they are not suitable for taking into account micro-elasticity, in particular high micro-elasticity, of the materials being examined, because these techniques involve visual observation of the indent following the indenting and determination of the hardness on this basis. The so-called Martens hardness, on the other hand, is determined mathematically using the indentation curve. In the context of the present disclosure, hardness in particular refers to the so-called Martens hardness.

It has been found that the real-life loads to which a sheet-like glass article is exposed can only be insufficiently described and simulated by an isolated consideration of abrasion, scratch and/or impact loads. For example, loads actually occurring under real-life conditions may comprise abrasion occurring on a surface with sharp particles, and the impact load, for example, that occurs when a test item falls on a sheet-like glass article to determine impact resistance is only partially, if at all, comparable to the load that occurs when an assembled, i.e. built-in sheet-like glass article falls on a surface.

Generally, it has been found that the hardness plays an important role when glasses or glass articles are used as covers (or cover sheets) for mobile electronic devices. As a rule, the higher the hardness of the glass or the glass article, the higher the scratch resistance.

There are generally two approaches to increase the surface hardness of covers, i.e. cover sheets, in order to avoid scratching:

One possibility is to use very hard transparent materials. For example, it is known to use so-called “sapphire glasses” (single crystals made of corundum). These are used as bezels for watches, for example. Such materials become scratched only very little, so their tendency to become scratched is very low. However, these materials are very difficult to process and very brittle. This also means that breakage can occur even upon minor surface damage. In other words, although these very hard materials are scratch-resistant so that they get scratched only when subjected to high loads, the latter can very quickly lead to material failure due to breakage.

Another possibility of increasing the scratch resistance of a cover sheet is to apply hard material layers on the cover sheet. Such coatings are usually less than 2 μm in thickness in order to keep visual conspicuousness as low as possible, and they are applied by common coating processes such as sputter-deposition. The advantage of such a procedure is that it allows to use cover sheets made of glass or comprising glass, for example a sheet-like glass article. In other words, this allows to use a material for the cover sheet, which is easy to process, and which can be enhanced in terms of its scratch resistance which is rather low in comparison to hard materials, by a coating.

However, this in turn has the drawback that a complex coating step is necessary. Furthermore, coating processes which are usually used for applying hard material layers are not suitable for coating three-dimensionally shaped substrates. Moreover, the application of the coating on corners and edges of the sheet-like glass article to be coated is not possible in this way. Furthermore, the hardness gradient between the sheet-like glass article and the coating is very steep. This often leads to delamination at the interface between these two materials, in particular when subjected to thermal or mechanical loads.

It has now been found that the plastic or elastic behavior of a material such as a glass also plays a major role in its susceptibility to scratching. This is because scratching introduces temporary stresses into the material, which can be absorbed by an elastic behavior and can relax without damage once the load has been relieved. However, if the introduced temporary stresses lead to a plastic deformation of the material, temporary stresses become permanent stresses which can lead to a reduction in strength, in the worst case to breakage when the load is removed.

There is therefore a need for improved sheet-like glass articles for use as a cover sheet, which are sufficiently scratch-resistant and at the same time exhibit low brittleness.

### SUMMARY

Therefore, the object of the invention is to provide a sheet-like glass article, in particular a glass article which is suitable for being used as a cover sheet, which at least partially mitigates the problems of the prior art. Further aspects relate to the use of such a glass article, to a glass composition, and to a method for its production.

According to a first aspect, the present disclosure accordingly relates to a chemically toughened or at least chemically toughenable sheet-like glass article which comprises a glass with a composition comprising Al2O3, SiO2, Li2O, and B2O3, and the glass and/or the glass article contains not more than 7 wt % of B2O3, preferably not more than 5 wt % of B2O3, most preferably not more than 4.5 wt % of B2O3. In other words, the glass or the glass article is a lithium aluminum borosilicate glass (LABS glass) or a lithium aluminum borosilicate glass article, although the B2O3 content in the glass and/or glass article is limited.

Such an embodiment of a glass article is advantageous, since it has been found that, in a surprisingly simple way, a glass article can be obtained with or from such an LABS glass, which is capable of advantageously combining high surface hardness with a high prestress, i.e. a highly toughened state, and that at the same time good mechanical resistance can be achieved to loads relevant in practical use, such as so-called “sharp impact”.

This is all the more surprising since it was previously known that although a certain B₂O₃ content may be suitable for increasing the scratch resistance of a glass or a glass article, it has also been shown that this effect is limited.

Surprisingly, however, it has been found that it is not so much the increase in scratch resistance what leads to an improvement in the performance properties of a glass article to be used as a cover sheet, for example. Rather, it has been found that in the case of LABS glasses the mechanical properties, in particular the elastic properties of the glass or the glass article can be improved in a highly advantageous way, in particular also in the toughened state. The reason for this is not fully understood, but the inventors assume that these highly advantageous properties of the glass or the glass article are caused by the B2O3 content in a lithium aluminum silicate glass.

For this purpose, it can be preferable that the glass or the glass article has a certain minimum content of B₂O₃. According to one embodiment, the glass and/or the glass article therefore comprises at least 0.5 wt % of B₂O₃, preferably at least 1.0 wt % of B₂O₃, most preferably at least 1.4 wt % of B₂O₃.

According to a further aspect, the present disclosure relates to a sheet-like glass article, in particular a sheet-like glass article as described above, which has at least one of the following features.

In a hardness test procedure based on or in compliance with DIN EN ISO 14577, when indented using a Vickers indenter, the glass article has an E* modulus (also known as plate modulus) of not more than 87 GPa for an indentation depth of 1 μm, and/or an E* modulus of not more than 80 GPa for an indentation depth of 2 μm, and/or an E* modulus of not more than 78 GPa for an indentation depth of 3 μm, with a lower limit of the E* modulus of preferably at least 72 GPa in each case.

In a hardness test procedure based on or in compliance with DIN EN ISO 14577, when indented using a Vickers indenter, the glass article preferably exhibits an elastic component of deformation of at least 58% for an indentation depth of 1 μm.

The E* modulus is the plate modulus which is defined as

$${E}^{*} = \frac{{E}_{IT}}{1 - {υ}_{s}^{2}}$$

where EIT is the modulus of indentation and vₛ is the Poisson's ratio of the sample.

Furthermore, the following definitions apply for the E* modulus and the indenter's Young's modulus EIT, in compliance with the DIN EN ISO 14577-1 standard:

$${E}^{*} = \frac{1}{\frac{1}{{E}_{r , n}} - \frac{1 - ( {υ}_{i}^{2} )}{{E}_{i}}} = \frac{{E}_{IT}}{1 - ( {υ}_{s}^{2} )}$$

$${E}_{IT} = \frac{1 - {( {υ}_{s} )}^{2}}{\frac{1}{{E}_{r , n}} - \frac{1 - {( {υ}_{i} )}^{2}}{{E}_{i}}}$$

with vₛ Poisson's ratio of the sample, vᵢ Poisson's ratio of the indenter (0.07 for diamond) (e.g. citation [6]), Eᵣ reduced elastic modulus upon indenter contact, and Eᵢ Young's modulus of the indenter (1,140 GPa for diamond) (e.g. citation [6])

### BRIEF DESCRIPTION OF THE DRAWINGS

The invention will now be explained in further detail with reference to the figures in which:

FIG. 1 is a schematic diagram of the indenting process;

FIG. 2 shows a schematic view of the measuring principle during the scratching process;

FIG. 3a shows an exemplary view of a “good” result of the scratch test;

FIG. 3b shows an exemplary view of a “bad” result of the scratch test, in which the conchoidal fracture is visible only after the start of the relative movement of the indenter relative to the test specimen;

FIG. 3c shows an exemplary view of a “bad” result of the scratch test, in which the conchoidal fracture is visible already with the start of the relative movement of the indenter relative to the test specimen;

FIG. 4 shows an overall view of the set drop test setup with the individual components labeled;

FIG. 5 shows the sample holder and the trigger mechanism of the set drop test setup;

FIG. 6 shows the aluminum case and the plastic plate as a sample holder and sample dummy;

FIG. 7 shows the alignment of the sample dummy using a 2D spirit level;

FIG. 8 illustrates measurement results of the hardness test for different glasses or glass articles;

FIG. 9 shows the plate modulus E* as a function of the depth of indentation for different glasses or glass articles;

FIG. 10 shows the elastic component of deformation during a hardness test as a function of the indentation depth for different glasses or glass articles;

FIG. 11 is a schematic view, not drawn to scale, of a glass article according to one embodiment; and

FIG. 12 is a schematic sectional view, not drawn to scale, through a glass article according to one embodiment.

### DETAILED DESCRIPTION

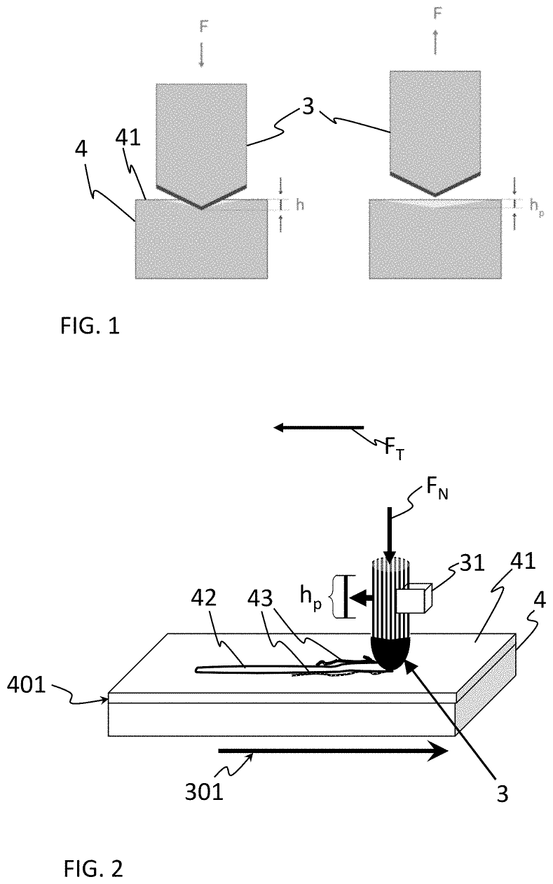

FIG. 1 shows a schematic diagram of an indentation process. Here, a force F acts on an indenter 3. The force acts in the normal direction to the surface 41 of a test specimen or sample 4, the hardness of which is to be determined, and is therefore referred to as normal force. The indentation depth or penetration depth is determined perpendicular to the surface 41 and is denoted by h and hₚ in FIG. 1.

The hardness test based on or in compliance with DIN EN ISO 14577 is a test that determines the so-called Martens hardness. In the context of the present disclosure, this determination of hardness for the considered glass articles is executed as follows:

The indentation is performed using a Vickers indenter at a normal force between 0.1 N and 5 N using the Micro-Combi-Test (MCT) test device from csm. The indentation is performed at a relative room humidity between 30% and 50%. The indentation and evaluation are executed in compliance with DIN EN ISO 14577, although it is important to note that DIN EN ISO 14577 relates to metals and that a corresponding standard for testing brittle materials is not existent. Insofar, the Martens hardness is determined in a similar manner or based on the test procedure for metals or ductile materials as described in DIN EN ISO 14577. For determining the parameters HM (Martens hardness), E* (plate modulus), and 11 (elastic component), ten indentations per force level were made, and the mean values were calculated.

A Vickers indenter is an equilateral diamond pyramid having an opening angle of 136°, determined between the lateral faces of the pyramid. The indenter is also described in DIN EN ISO 6507-2, for example.

Such a configuration of a glass article is very advantageous as it allows, in a very surprisingly way, to achieve particularly good scratch resistance with, at the same time, good resistance of the glass article to so-called sharp-impact loads (for example in a what is known as a “set drop test”).

The set drop test which is intended to simulate a real-life application case is preferably executed as follows:

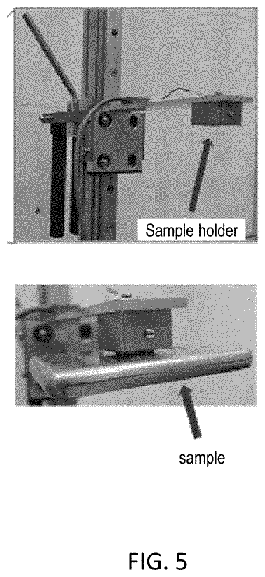

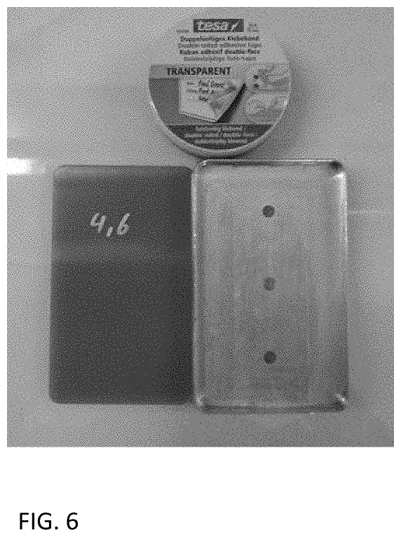

A glass sheet is fixed in a sample holder and dropped onto a predefined surface from cumulative falling heights. An overview of the overall setup is shown in FIG. 4. The glass article used in the set drop test has a length of 99 mm and a width of 59 mm and is magnetically fixed in the sample holder with a sample dummy, as illustrated in FIG. 5. First, for this purpose, a plate made of plastics material is adhered in a metal housing which has the shape and weight of a holder for a mobile device such as a smartphone, using a double-sided adhesive tape. For example, plastic plates with a thickness between 4.35 mm and up to 4.6 mm are suitable for this purpose (see FIG. 6). The adhering is preferably achieved using a double-sided adhesive tape with a thickness of about 100 μm. The sheet-like glass article to be tested is then adhered to the plastic plate by a double-sided adhesive tape, preferably a double-sided adhesive tape with a thickness of 295 μm, in particular a double-sided adhesive tape of the tesa® brand, product number 05338, in such a way that a distance between 350 μm and 450 μm is obtained between the upper edge of the housing or holder and the upper edge of the glass article. The glass article is elevated beyond the frame of the housing, and there must be no direct contact between the glass body and the aluminum housing. The so obtained “set” with a weight of 177.5 g, which simulates the installed state of a glass article in a mobile terminal device and is a kind of “dummy” for a real mobile terminal device, in particular a smartphone in this case, is then dropped with the glass side down onto a surface of DIN A4 size, the so-called impact surface, with an initial speed of zero in the vertical direction, i.e. the falling direction. The impact surface is prepared as follows: Sandpaper with an appropriate grain size, for example 60 (#60), is adhered on a base plate using a double-sided adhesive tape, for example an adhesive tape with a thickness of 100 μm. The adhesive tape used here was tesa® (10 m/15 mm), transparent, double-sided, product number 05338. In the context of the present disclosure, the grain size is defined in accordance with the standards of the Federation of European Producers of Abrasives (FEPA), for examples see DIN ISO 6344, inter alia, in particular DIN ISO 6344-2:2000-04, Coated abrasives—Grain size analysis—Part 2: Determination of grain size distribution of macrogrits P 12 to P 220 (ISO 6344-2: 1998).

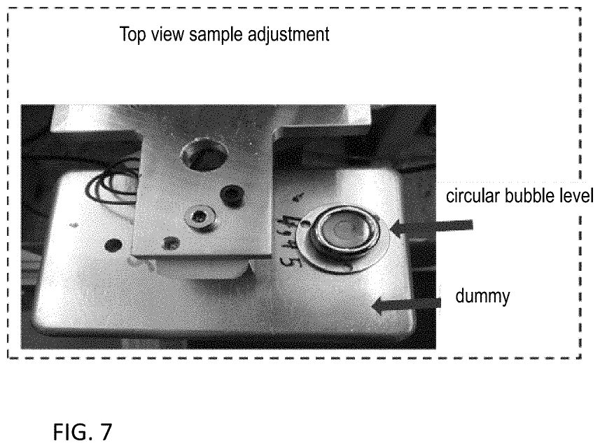

The base plate must be solid and is preferably made of aluminum or alternatively of steel, but may also be in the form of a stone slab comprising granite or marble, for example. The base plate, which is an aluminum base plate for the specifications disclosed here, has a weight of approx. 3 kg. The whole sandpaper must be provided with tape and adhered without bubbles. The impact surface must be used for not more than ten drop tests and must be replaced after the tenth drop test. The sample, i.e. the obtained set, is placed in the test device and aligned using a 2D spirit level (circular bubble level) so that the set is mounted horizontally, with the sheet-like glass article facing the ground, i.e. facing towards the impact surface (see FIG. 7). The first drop height is 25 cm, subsequently the dropping is effected from a height of 30 cm. If still no breakage occurs, the drop height is increased in steps of 10 cm until the glass breaks. The height of breakage, the starting point of the fracture, and the fracture pattern are noted. The test is performed on 15 samples and an average is calculated.

It can be advantageous to attach the sheet-like glass article on the plastic plate such that the sheet-like glass article remains adhered to a film in the event the glass breaks, on the one hand in order to be removed as easily as possible, but on the other hand also to allow for examination of the glass article. For this purpose, it can be advisable, in addition to the adhesive tapes that are employed, to arrange a self-adhesive film, for example a film as is used for wrapping books, between the plastic plate and the sheet-like glass article. The broken sheet-like glass article can then be removed by means of this film.

As stated above with respect to the prior art, it was found hitherto, that materials commonly referred to as very “hard”, such as Al₂O₃ (also known as “sapphire” or “sapphire glass”), in fact exhibit high scratch resistance, but at the same time are very brittle, so that they quickly fail due to breakage in a real-life stress situation such as the so-called set drop test.

Now, with the configuration of the glass article according to embodiments, it is possible, surprisingly, to obtain a scratch-resistant glass article which at the same time also shows good performance in a test that simulates a real-life stress event such as the aforementioned set drop test.

In the context of the present disclosure, scratch resistance is preferably determined as follows:

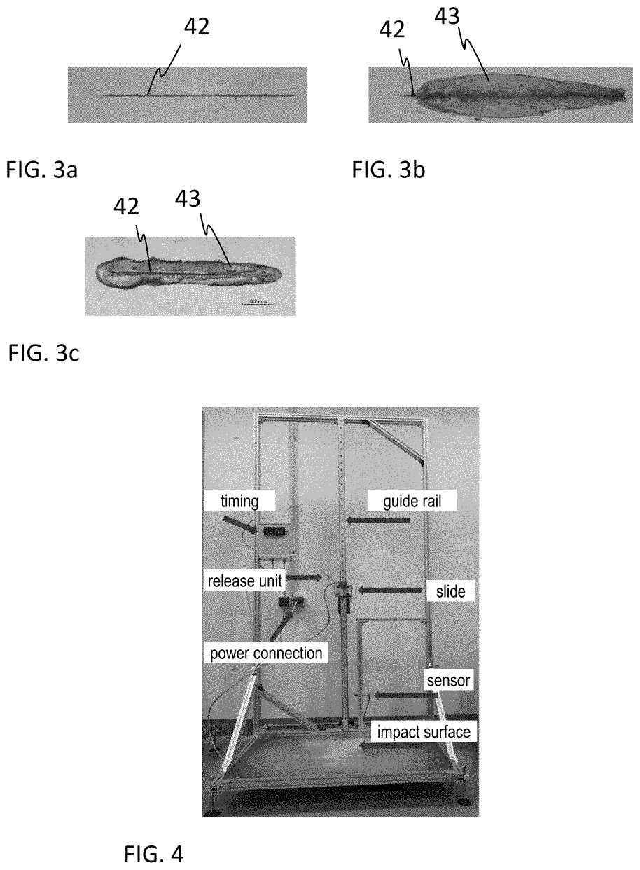

The scratch resistance is also tested with the Micro-Combi-Test (MCI) device from csm. A schematic view of the measuring principle during the scratching process is shown in FIG. 2. The scratch test is performed using an indenter 3 which in the context of the present disclosure is in the form of a Knoop indenter, with a normal force (denoted F_{N} here) of 4 N. The indenter 3 is moved over a distance of 1 mm at a rate of 24 mm per min, in particular in the direction of arrow 301. It is equally possible to keep the Knoop indenter stationary and to move the sample 4 relative thereto. In addition to the normal force F_{N}, there is also the tangential force FT acting on the surface 41 of the sample 4 to be tested, which acts in parallel to the surface 41. The penetration depth (or penetration height, see FIG. 1, denoted by h and hₚ there) is determined by a sensor 31. The result obtained by the test in particular depends on the material, size, and shape of the indenter 3 and on the nature of the tested sample 4, for example on the material of the sample 4 and/or its microstructure. In the case where the sample 4 has a surface layer 401 with a composition and/or other characteristics differing from the bulk properties, for example in the form of a coating or a layer that was obtained by an ion exchange, for example, the result obtained by this scratch test may also depend on the thickness, composition, and/or microstructure of the surface layer 401. For the test, 50 scratches 42 are introduced next to one another into the sample 4 or into its surface 41, at a relative humidity between 30% and 50%, with the indenter 3 in the form of a Knoop indenter, as stated above. Evaluation is performed as a visual assessment of the scratches 42 or scratch tracks 42 along conchoidal fractures 43. The number of scratches or scratch tracks 42 with conchoidal fractures 43 is documented. An exemplary view of a good sample without conchoidal fractures 43 along the scratch track or scratch 42 is shown in FIG. 3a. A sample that is poor in the sense of this scratch test, showing conchoidal fractures 43 along the scratch track or scratch 42, is shown in FIGS. 3b and 3c, respectively. In the case of the view in FIG. 3b, the conchoidal fracture arises only after the start of the relative movement of the indenter 3 relative to the test specimen 4, which can be identified from an initial scratch track 42 without conchoidal fracture 43 and from the conchoidal fracture 43 only arising after the start of the relative movement. In the case of the view in FIG. 3c, the conchoidal fracture arises already at the start of the relative movement of the indenter 3 relative to the test specimen 4, which can be identified from the lack of a mere scratch track 42, as conchoidal fractures 43 already occur with the start of the relative movement of the indenter 3 relative to the test specimen 4 and are obvious by their lateral width in which the scratch track 42 extends.

Here, conchoidal fracture is considered to involve a widening of the scratch track or scratch by at least three times the lateral width of the initial scratch track in the surface 41 and along the extension parallel to the surface 41 and perpendicular to the scratch track, i.e. perpendicular to the direction of arrow 301. If a conchoidal fracture arises already with the start of the movement of the indenter or the test specimen 4, the conchoidal fracture is considered to amount to at least three times the value of the lateral width of the indenter 3 in its state in which it has penetrated the glass in the plane of the surface 41 of test specimen 4.

A Knoop indenter is a diamond tip with a rhombic shape. The indenter is described in DIN EN ISO 4545, for example.

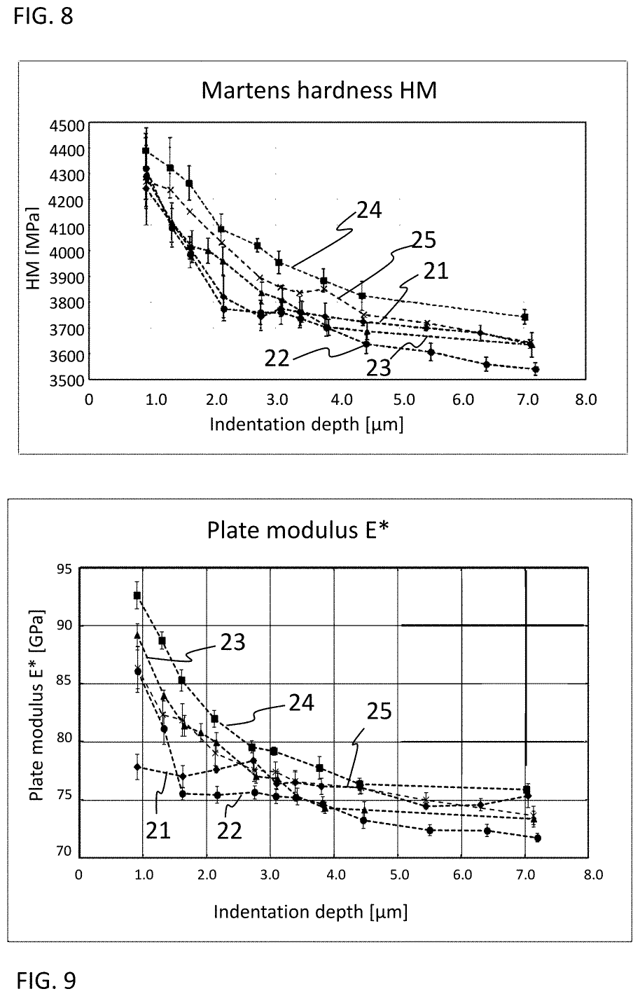

With glasses or glass articles according to embodiments, a result of 0 can surprisingly be achieved (for example with a glass or glass article from which the set of measured values 25 is obtained, see FIGS. 8 to 10), i.e. no conchoidal fracture introduced by any of the scratches or scratch tracks. This is all the more surprising since comparative samples of glass articles which comprise a glass of a different composition or which exhibit a different physical behavior when indented, can have between 30 and 50 scratches with conchoidal fracture (e.g. a glass or glass article from which the set of measured values 23 or 24 is obtained, see FIGS. 8 to 10).

The inventors assume that this very surprisingly good scratch resistance can be achieved by a combination of suitable toughening parameters, that is to say it may in particular represent a result of the toughening introduced into a glass article.

The present disclosure therefore also relates to a sheet-like glass article, preferably a sheet-like glass article according to embodiments of the disclosure, which has a prestress as preferably obtained by at least one ion exchange whereby, together with the introduction of the prestress, an elastic component η of deformation is increased up to a depth of about 3 μm.

The special characteristic of the glass article according to the present disclosure can therefore be considered to be the particular elastic properties the glass article has in a near-surface area, in particular a near-surface area up to about 3 μm, in particular up to about 2 μm, and even already at a depth of about 1 μm. This is where a particularly high elastic component of at least 58%, for example, is found in a hardness testing procedure based on or in compliance with DIN EN ISO 14577.

Although glasses are known in which even higher elastic components can be achieved, these glasses have a different structure and in particular cannot be chemically toughened to the same extent as the preferred glasses or glass articles according to embodiments. The inventors assume that the particularly good properties of the glass or glass article according to the present disclosure could be attributed to the special glass structure which contains a certain amount of B₂O₃. Unlike SiO₂, for example, B₂O₃ often does not form any or at least fewer three-dimensional links. Instead, it tends to form two-dimensionally linked structures which, for illustration purposes, may also be compared with the two-dimensional structures of graphite. It is therefore assumed that due to the certain, albeit small, proportion of the network former B₂O₃ in the glass or glass article, a glass structure can be obtained in which the borate glass structures may at least promote a kind of sliding effect in the glass network, so that increased elasticity can be observed at least in a near-surface area.

According to one embodiment of the glass article, the glass and/or the glass article comprises not more than 3 wt % of P₂O₅, preferably not more than 2 wt % of P₂O₅, and most preferably not more than 1.7 wt % of P₂O₅. P₂O₅ is an optional constituent of the glass or glass article according to the present disclosure. P₂O₅ is a glass constituent that has a network forming effect and can increase the meltability of a glass. P₂O₅ may also facilitate the ion exchange, i.e. can lead to shorter process durations. The content in the glass or glass article is preferably at least 0.1 wt %, more preferably at least 0.25 wt %, and most preferably at least 0.5 wt %. However, an excessive content of P₂O₅ in a glass or glass article can reduce the chemical stability of the glass or glass article, or the P₂O₅ may cause segregation phenomena. P₂O₅ may also lead to difficulties in production, since the material of the melting unit might be attacked. Therefore, the phosphate content is preferably limited in the glass or glass article according to the present disclosure and amounts to not more than 3 wt % of P₂O₅, preferably at most 2 wt %, most preferably at most 1.7 wt %.

Furthermore, it has surprisingly been found that it is specifically the combination of the constituents B₂O₃ and P₂O₅, in particular in the amounts as mentioned above, which enables a particularly advantageous implementation of a scratch-resistant and at the same time highly toughened glass article. Here, P₂O₅ is able to compensate for the negative effects of B₂O₃ with regard to the toughening properties. If, for example, a B₂O₃ content is chosen that results in B₂O₃ being present in the glass in trigonal form, then this leads to a higher scratch resistance due to the presumably existing slip planes, similar to the structure of graphite. However, if there is a sufficiently high percentage of alkalis and alkaline earths in the overall system, so that B₂O₃ is also present in tetragonal form, it will in particular more strongly bind to the alkalis which are crucial for the ion exchange. This will results in a more difficult ion exchange. A certain amount of P₂O₅ can help here, since the P₂O₅ forms chains in the glass and thus presumably provides channels in the glass, which can facilitate the ion exchange, considered overall.

In order to create a prestress, i.e. a toughened state, at least in the near-surface area of the glass article up to 3 μm, in particular up to 2 μm, and especially up to a depth of 1 μm, it is furthermore advantageous if the glass or the glass article contains a certain minimum content of Na₂O. Na₂O is a network converter and is therefore in particular capable of influencing the exchangeability and consequently the capability of being toughened and accordingly also the prestress of a glass article which is achievable or achieved. According to one embodiment, the glass and/or the glass article comprises at least 0.8 wt % of Na₂O, while the glass and/or the glass article preferably comprises not more than 8 wt % of Na₂O, preferably not more than 7.5 wt % of Na₂O, and most preferably not more than 7 wt % of Na₂O. In other words, according to this embodiment, the glass and/or the glass article is designed as a glass or glass article comprising Na₂O. An advantage of the glass and/or the glass article comprising Na₂O is that in this case an ion exchange of sodium ions by potassium ions is possible. This can lead to particularly advantageous embodiments of a glass article with regard to its mechanical properties.

It has in particular been found that the interaction of the glass constituents, in particular the constituent B₂O₃ with Na₂O, allows for a particularly advantageous configuration of the glass article. This is because as a network converter, Na₂O also has an impact on the properties of the glass article at the interface thereof. As stated above, Na₂O also enables the exchangeability by potassium ions. This means that the near-surface area of the glass article can be designed in such a way that sodium is exchanged by potassium in the near-surface area. It is precisely in this area close to the surface where the beneficial, highly advantageous elastic properties of the glass article are obtained, which in particular lead or can lead to the very good scratch results of glass articles according to embodiments as explained above, with only very little or in some cases even no conchoidal fracture at all.

The beneficial mechanical, in particular elastic properties of the glass article according to the present disclosure can advantageously be promoted by a certain content of K₂O in the glass and/or the glass article. According to one embodiment, the glass and/or the glass article comprises not more than 1 wt % of K₂O, preferably up to 0.8 wt % of K₂O, and most preferably up to 0.7 wt % of K₂O, and preferably the glass and/or the glass article comprises at least 0.1 wt % of K₂O. For adjusting optimized mechanical properties, in particular enhanced wear resistance of a glass or a glass article, in particular optimized sharp-impact strength with at the same time good prestress and improved scratch resistance, it can be advantageous if the glass comprises a certain amount of K₂O. It has in particular been found that the ion exchange and thus the capability of being toughened can be improved by K₂O. This is attributed to the loosened glass structure as caused by the potassium ions. Furthermore, K₂O improves the meltability of the glass. Preferably, the glass and/or the glass article according to the present disclosure comprises at least 0.1 wt % of K₂O, most preferably at least 0.2 wt % of K₂O.

Li₂O is a necessary constituent of the glasses and glass articles of the present disclosure. The content of lithium oxide in the glasses and/or glass articles according to the present disclosure in particular provides for a good strength of toughened glasses in static strength tests such as for flexural strength according to the four-point bending test, or the determination of strength according to a double ring test, as well as the resistance to blunt impact loads, such as in the ball drop test, and to sharp impact loads, i.e. the impact on the surface of a glass or a glass article with particles that have an angle of less than 100° (which can be demonstrated in what is known as the set drop test, for example). However, the glasses and/or glass articles according to the present disclosure are furthermore distinguished by improved hardness, which becomes obvious in a hardness testing procedure for determining the so-called Martens hardness, for example. Lithium oxide is advantageous because it enables ion exchange by sodium and thus provides for a high capability of being toughened and high prestress of the glass or glass article. The glasses and/or glass articles according to the present disclosure therefore contain at least 3 wt % of Li₂O, preferably up to at least 3.5 wt % of Li₂O. However, according to the present disclosure, the content of Li₂O is limited. For example, segregation may arise if the Li₂O content is too high. Therefore, the glasses and glass articles contain at most 5.5 wt % of Li₂O.

It is advantageous to guarantee a certain minimum percentage of SiO₂ in the glass or glass article in order to improve the chemical resistance and also the mechanical properties of the glass or glass article. The latter is attributed to the promoting of the formation of a rigid basic glass network which relaxes little during ion exchange and thus permits to achieve high prestress. However, glasses with an excessive percentage of SiO₂ are not economically sensible in a melting process with subsequent hot forming, due to the extremely high melting temperatures of pure SiO₂. Furthermore, an excessive content of SiO₂ can lead to increased brittleness of the glass or the glass article, so that the content of SiO₂ must be limited for these reasons.

It is therefore advantageous if the glass or if the glass article comprises sufficient SiO₂ to provide for a sufficient capability of being toughened and sufficient prestress. Therefore, according to one embodiment, the glass or glass article comprises at least 57 wt % of SiO₂, preferably at least 59 wt % of SiO₂, and most preferably at least 61 wt % of SiO₂. However, the content of SiO₂ in the glass or glass article is preferably limited in order to prevent the glass or glass article from becoming too brittle as a result. According to one embodiment, the glass or glass article preferably comprises at most 69 wt % of SiO₂, preferably at most 67 wt %.

Al₂O₃ is a well-known network former in glasses with a sufficiently high alkali content, which is in particular added to alkali-containing silicate glasses. The addition of Al₂O₃ reduces the number of oxygen at points of separation, so that a rigid network can be obtained despite a certain content, which is advantageous for the development of a good toughening capability and prestress. In addition, Al₂O₃ facilitates ion exchange. In this way, the toughenability of an alkali-containing silicate glass can be improved, so that a particularly highly toughened glass article can be obtained with such a glass. Therefore, the minimum content of Al₂O₃ in the glass is advantageously 17 wt % according to one embodiment. However, an excessive content of Al₂O₃ reduces the chemical resistance of the resulting glass or glass article, in particular acid resistance, and moreover increases the melting temperature. Also, it is advantageous for the formation of a glass article which also shows good performance in practical applications, for example high surface hardness and/or good scratch resistance, if the glass network is not too rigid, but rather still flexible or if it has elastic components. Therefore, according to further embodiments, the content of Al₂O₃ in the glass or glass article is preferably limited and preferably is not more than 25 wt %, most preferably not more than 21 wt %.

The total of Al₂O₃ and SiO2 contents, given in percent by weight, is preferably between at least 75 and at most 92, preferably not more than 90; and/or the total content of network formers in the glass and/or glass article is not more than 92 wt %, most preferably not more than 90 wt %.

A content of the network formers Al₂O₃ and SiO₂ of at least 75 wt % is particularly advantageous because a sufficient amount of glass formers will be provided in this way. In other words, it is ensured in this way that a vitreous material is obtained and that the risk of devitrification during the production of the glass or glass article is reduced. On the other hand, the content of the aforementioned network formers should not be too high, because otherwise the resulting glass will not be easily meltable any more. Therefore, the content of Al₂O₃ and SiO₂ is preferably limited and is not more than 92 wt %, preferably not more than 90 wt %. The total content of network formers in the glass or glass article is preferably not more than 92 wt %, most preferably not more than 90 wt %.

According to a further embodiment, the glass article has a thickness of at least 0.4 mm and at most 3 mm.

Preferably, the glass article has a thickness of at least 0.5 mm.

The thickness of the glass article is furthermore preferably limited and, according to one embodiment, is at most 2 mm, preferably not more than 1 mm.

Another aspect of the present disclosure relates to a lithium aluminum borosilicate glass, comprising the following constituents, in wt %:
SiO₂ 57 to 69, preferably 59 to 69, most preferably 61 to 69, preferably with a respective upper limit of 67,
Al₂O₃ 17 to 25, preferably 17 to 21,
B₂O₃ 0.5 to 7, preferably 0.5 to 5, most preferably 0.5 to 4,5, preferably with a respective lower limit of 1.0 wt % of B₂O₃, most preferably at least 1.4 wt % of B₂O₃ in each case,
Li₂O₃ to 5.5, preferably 3.5 to 5.5,
Na₂O 0.8 to 8, preferably 0.8 to 7.5, most preferably 0.8 to 7,
wherein, preferably, the total of Al₂O₃ and SiO₂ contents, given in percent by weight, is between at least 75 and at most 92, most preferably not more than 90.

Such a glass is advantageous because it is designed to be capable of being chemically toughened, so that chemically toughened glass articles that exhibit particularly high strength in the so-called set drop test are obtained, even when coarse grain sizes such as grain size 60 is used. At the same time, the advantageous surface hardness and/or scratch resistance of glass articles as described above is achieved, since the glass is designed so as to exhibit a high elastic component at least in the case of deformations or indentations in a surface layer. Despite its high content of glass formers, here in particular preferably a high content of the glass formers SiO₂ and Al₂O₃ of at least 75 wt %, the glass according to the present disclosure is still meltable surprisingly well.

The inventors assume that the advantageous properties of the glass or glass article according to embodiments of the present disclosure may be attributable to the fact that a glass with the composition within the above-mentioned limits is designed so that it can be toughened such that a chemically highly toughened glass article can be obtained, which nevertheless, most surprisingly, is elastically deformable in the case of deformation, at least to a certain extent, and is therefore less prone to brittle fracture or conchoidal fracture when the surface is scratched than would be the case with prior art hard materials such as Al₂O₃.

According to one embodiment of the lithium aluminum borosilicate glass, this is given by the following composition, in wt %:
SiO₂ 57 to 69, preferably 59 to 69, most preferably 61 to 69, preferably with a respective upper limit of 67,
Al₂O₃ 17 to 25, preferably 17 to 21,
B₂O₃ 0.5 to 7, preferably 0.5 to 5, most preferably 0.5 to 4,5, preferably with a respective lower limit of 1.0 wt % of B₂O₃, most preferably at least 1.4 wt % of B₂O₃ in each case,
Li₂O 3 to 5.5, preferably 3.5 to 5.5,
Na₂O 0.8 to 8, preferably 0.8 to 7.5, most preferably 0.8 to 7,
K₂O 0 to 1, preferably 0 to 0.8, most preferably 0 to 0.7,
MgO 0 to 2, preferably 0 to 1.5, most preferably 0 to 1,
CaO 0 to 4.5,
SrO 0 to 2, preferably 0 to 1.5, most preferably 0 to 1,
ZnO 0 to 3, preferably 0 to 2, most preferably 0 to 1.5,
P₂O₅ 0 to 3, preferably 0 to 2, most preferably 0 to 1.7,
ZrO₂ 0 to 3, preferably 0 - 2.7, most preferably 0 to 2,
wherein impurities and/or refining agents and/or coloring constituents may additionally be contained in amounts of up to 2 wt %.

ZrO₂ implies the advantage that, if the proportion of alkalis is high enough, it will become integrated in the SiO₂ network as a glass-forming agent and contributes to the strengthening of the network. In addition to chemical resistance, it also improves mechanical properties. Furthermore, a certain amount of B₂O₃ leads to a stabilization of the ZrO₂ in the glass or prevents the formation of ZrO₂ crystals.

In embodiments, the glass of the glass article may contain ZrO₂ and most preferably comprises a ZrO₂ content of at least 0.2 wt % as a lower limit.

Yet another aspect of the present disclosure relates to a method for producing a glass article according to the presently disclosed embodiments, comprising the following steps: an ion exchange in an exchange bath comprising between at least 20 wt % and up to 100 wt % of a sodium salt, preferably sodium nitrate NaNO₃, for a duration of at least 2 hours, preferably at least 4 hours and not more than 24 hours, at a temperature between at least 380° C. and at most 440° C., optionally with a potassium salt added to the exchange bath, in particular potassium nitrate KNO₃, in particular such that the total of the sodium salt and potassium salt contents add up to 100 wt %; and, optionally, a second ion exchange in an exchange bath comprising between 0 wt % and 10 wt % of a sodium salt, preferably sodium nitrate NaNO₃, based on the total amount of salt, for a duration of at least one hour and not more than 6 hours, at a temperature of the exchange bath of at least 380° C. and at most 440° C., with a potassium salt added to the exchange bath, in particular potassium nitrate KNO₃, in particular such that the total of the sodium salt and potassium salt contents add up to 100 wt %; and optionally one or more further ion exchange steps.

According to yet another aspect, the present disclosure furthermore relates to the use of a glass article as a cover sheet, in particular as a cover sheet for entertainment electronics devices, in particular for display devices, screens of computer devices, measurement devices, TV sets, in particular as a cover sheet for mobile devices, in particular for at least one device selected from the group consisting of mobile terminal devices, mobile data processing devices, in particular cell phones, mobile computers, palmtops, laptops, tablet computers, wearables, watches, and time measuring devices, or as a protective glazing, in particular a protective glazing for machines, or as a glazing in high-speed trains, or as safety glass, or for automotive glazing, or in diving watches, or in submarines, or as a cover sheet for explosion-proof devices, in particular for those in which the use of glass is mandatory.

### EXAMPLES

Comparison glasses which do not contain any B₂O₃ in their composition and also do not exhibit the values of the elastic component 11 as will be discussed in more detail below, are given in the form of a soda-lime glass labeled by reference numeral 23, and a Li—Al—Si glass labeled by reference numeral 24, in particular a lithium aluminum silicate glass with a Li₂O content from 4.6 wt % to 5.4 wt %, and an Na₂O content from 8.1 wt % to 9.7 wt %, and an Al₂O₃ content from 16 wt % to 20 wt %.

The glass articles labeled by reference numerals 21, 22, and 25 each comprise a lithium aluminum borosilicate glass or are made of this glass which contains the following constituents, in wt %:
SiO₂ 57 to 69, preferably 59 to 69, most preferably 61 to 69, preferably with a respective upper limit of 67,
Al₂O₃ 17 to 25, preferably 17 to 21,
B₂O₃ 0.5 to 7, preferably 0.5 to 5, most preferably 0.5 to 4,5, preferably with a respective lower limit of 1.0 wt % B₂O₃, most preferably at least 1.4 wt % of B₂O₃ in each case,
Li₂O 3 to 5.5, preferably 3.5 to 5.5,
Na₂O 0.8 to 8, preferably 0.8 to 7.5, most preferably 0.8 to 7,
wherein, preferably, the total of the of the Al₂O₃ and SiO₂ contents, based on percent by weight, is between at least 75 and at most 92, most preferably not more than 90.

The glass article denoted by reference numeral 21 has a B₂O₃ content of 3.6 wt % +/−0.5 wt %.

The glass article denoted by reference numeral 22 has a B₂O₃ content of 3.9 wt % +/−0.5 wt %.

The glass article denoted by reference numeral 25 has a B₂O₃ content of 2.8 wt % +/−0.5 wt %.

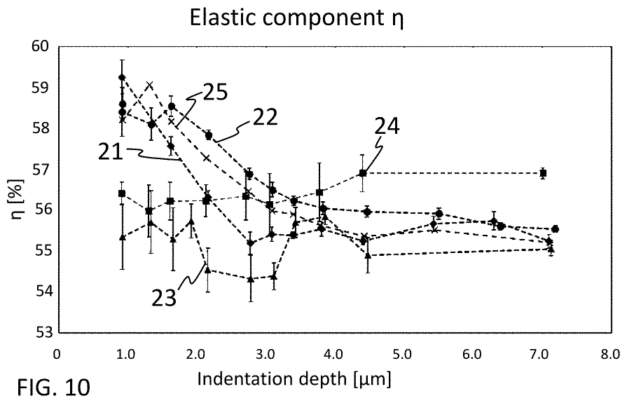

What is particularly advantageous and surprising in these glasses 21, 22, and 25 is their increased elastic component 11 of deformation during a hardness test as a function of indentation depth, as obtained up to a depth of approx. 4 μm after a suitable toughening process, for example an ion exchange in an exchange bath comprising between at least 20 wt % and up to 100 wt % of a sodium salt, preferably sodium nitrate NaNO₃, for a duration of at least 2 hours, preferably at least 4 hours and not more than 24 hours, at a temperature between at least 380° C. and at most 440° C., optionally with a potassium salt added to the exchange bath, in particular potassium nitrate KNO₃, in particular such that the total of the sodium salt and potassium salt contents add up to 100 wt %; and, optionally, a second ion exchange in an exchange bath comprising between 0 wt % and 10 wt % of a sodium salt, preferably sodium nitrate NaNO₃, based on the total amount of salt, for a duration of at least one hour and not more than 6 hours, at a temperature of the exchange bath of at least 380° C. and at most 440° C., with a potassium salt added to the exchange bath, in particular potassium nitrate KNO₃, in particular such that the total of the sodium salt and potassium salt contents add up to 100 wt %; and optionally one or more further ion exchange steps, as will be described in more detail below with reference to FIG. 10.

FIG. 8 shows the Martens hardness (HM), in MPa, as determined on five different chemically toughened glass articles, the five different glass articles each having a different glass composition. Different data points can be associated with each of these five different glass articles, and in FIG. 8 as well as in the following FIGS. 9 and 10 the data points for the first glass article are indicated by a diamond, for the second glass article by a circle, for the third glass article by a triangle, for the fourth glass article by a square, and for the fifth glass article by a cross in each case. In FIGS. 8 to 10, these different measured values and possible corresponding connecting lines or data lines obtained for these data points between these measured values are labeled 21 for the first glass article (diamond), 22 for the second glass article (circle), 23 for the third glass article (triangle), 24 for the fourth glass article (square), and 25 for the fifth glass article (cross). The measured values (or sets of measured values) 21, 22, and 25 were obtained for glasses or glass articles according to the present disclosure. The measured values or sets of measured values and data lines 23 and 24 were obtained for comparative examples. The third comparative example corresponds to a conventional soda-lime glass.

For the measured values of Martens hardness as shown in FIG. 8, a comparison of the measured values obtained for the different glasses or glass articles shows that the Martens hardness for the first, second, and fifth glass articles (corresponding to measured values or curves 21, 22, and 25) can be up to 25% higher, after having suitably been toughened as already mentioned above, in particular for indentation depths of up to about 4 μm, for example. A particularly high Martens hardness can be achieved in particular by combining a suitable glass composition and a suitable toughening process.

The increase in hardness values correlates with an increase in the Young's modulus or plate modulus E*. This is shown in the graph of FIG. 9, by way of example. Indicated are the measurement values obtained for the respective glasses or glass articles as well as a corresponding connecting line through these measurement points.

Generally, in a glass system, the hardness correlates with the Young's modulus, also known as modulus of elasticity. A higher Young's modulus leads to higher local stresses at crack ends when subjected to a load. Therefore, when scratching with a hard material, the higher Young's modulus leads to increased stress on the material. The ion exchange creates a gradual decrease in hardness and Young's modulus from the surface inwards. This gradual decrease avoids interfaces at which stress concentrations might arise. On the other hand, it is possible to efficiently mechanically process the material by grinding and polishing prior to being toughened by an ion exchange.

The glasses or glass articles according to the invention, for which the measured values and data lines or connecting lines 21, 22, and 25 are obtained, surprisingly lead to a smaller increase of the measured plate modulus for a similar increase in hardness as with the comparative examples obtained for measured values and connecting lines 23 and 24. This effect is most pronounced for the glass or glass article associated with measured values 21. This is related to the special structure of the LABS glass for which the toughening process was optimized in the present case.

Moreover, surprisingly, the glasses or glass articles according to the invention (see measured values 21, 22, and 25) exhibit a significantly higher elastic component 11 than the soda-lime glass (measured values 23) and the fourth glass of the LAS glass family or the fourth glass article (measured values 24), as can be seen from FIG. 10. The glass family of the LABS glasses exhibits similar values 21, 22, 25, which are clearly distinguished from the measured values 23 and 24 obtained for the comparative examples.

The elastic component furthermore correlates with the hardness. The combination of hardness, a relatively low Young's modulus or plate modulus (E* modulus) in this case, and a relatively high elastic component η leads to a significant improvement in the scratching behavior in near-surface areas of the chemically toughened glass article.

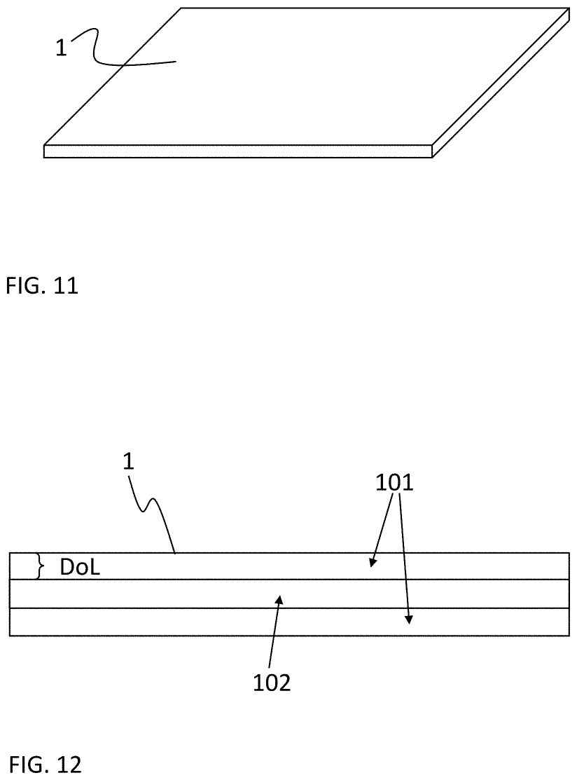

FIG. 11 is a schematic view, not drawn to scale, of a sheet-like glass article according to the presently disclosed embodiments.

FIG. 12 shows a schematic sectional view, not drawn to scale, of a glass article 1 according to the presently disclosed embodiments. Glass article 1 comprises two zones 101 provided at the two main surfaces or faces of the glass article, which are under compressive stress and accordingly are referred to as compressive stress zones. These compressive stress zones 101 have the dimension “DoL” as schematically indicated and also designated 41 in FIG. 2. The DoL may differs at the two faces of the sheet-like glass article in terms of its extent, but these differences usually are within measurement accuracy, so that for a sheet-like glass article 1 the DoL will usually be the same on both faces, at least within measurement accuracy.

Zone 102 which is under tensile stress, is located between the compressive stress zones 101.

### LIST OF REFERENCE SYMBOLS

1 Glass article

101

102

21, 22, 23, 24, 25 Sets of measured values and data lines obtained thereby

3 Indenter

31 Sensor

301 Movement direction of 3

4 Sample, test specimen

41 Surface to be tested of test specimen or sample 4

41 Scratch, scratch track

43 Conchoidal fracture

401 Surface layer of sample or test specimen 4

F, FN Force, normal force

FT Tangential force

h, hP Depth/height of penetration

DoL Depth of Layer, depth of compressive stress

What is claimed is:

1. A chemically toughened or chemically toughenable sheet-like glass article, comprising a glass with a composition comprising Al₂O₃, SiO₂, Li₂O, and B₂O₃, wherein the glass and/or the glass article comprises not more than 7 wt % of B₂O₃.

2. The glass article of claim 1, wherein the glass and/or the glass article comprises not more than 4.5 wt % of B₂O₃.

3. The glass article of claim 1, wherein the glass and/or the glass article comprises at least 0.5 wt % of B₂O₃.

4. The glass article of claim 1, wherein the glass and/or the glass article comprises at least 1.4 wt % of B₂O₃.

5. The glass article of claim 1, comprising a feature selected from a group consisting of:
an E* modulus of at least 72 GPa and not more than 87 GPa for an indentation depth of 1 μm in a hardness test procedure based on or in compliance with DIN EN ISO 14577 when indented using a Vickers indenter;
an E* modulus of at least 72 GPa and not more than 80 GPa for an indentation depth of 2 μm in a hardness test procedure based on or in compliance with DIN EN ISO 14577 when indented using a Vickers indenter;
an E* modulus of at least 72 GPa and not more than 78 GPa for an indentation depth of 3 μm in a hardness test procedure based on or in compliance with DIN EN ISO 14577 when indented using a Vickers indenter;
an elastic component of deformation of at least 58% for an indentation depth of 1 μm in a hardness test procedure based on or in compliance with DIN EN ISO 14577 when indented using a Vickers indenter; and
any combinations thereof.

6. The glass article of claim 1, comprising an ion exchange prestress that increases an elastic component 11 of deformation up to a depth of about 3 μm.

7. The glass article of claim 1, wherein the glass and/or the glass article comprises not more than 3 wt % of P₂O₅.

8. The glass article of claim 1, wherein the glass and/or the glass article comprises not more than 1.7 wt % of P₂O₅.

9. The glass article of claim 1, wherein the glass and/or the glass article comprises at least 0.8 wt % and not more than 8 wt % of Na₂O.

10. The glass article of claim 1, wherein the glass and/or the glass article comprises at least 0.1 wt % and not more than 1 wt % of K₂O.

11. The glass article of claim 1, wherein the glass and/or the glass article comprises at least 3 wt % and at most 5.5 wt % of Li₂O.

12. The glass article of claim 1, wherein the glass and/or the glass article comprises at least 57 wt % and not more than 69 wt % of SiO₂.

13. The glass article of claim 1, wherein the glass and/or the glass article comprises at least 17 wt % and not more than 25 wt % of Al₂O₃.

14. The glass article of claim 1, wherein the glass and/or glass article comprises a total content of Al₂O₃ and SiO₂ in a range between at least 75 wt % and at most 92 wt %.

15. The glass article of claim 1, wherein the glass and/or glass article comprises a total content of network formers of not more than 92 wt %.

16. The glass article of claim 1, wherein the glass article has a thickness of at least 0.4 mm.

17. The glass article of claim 1, wherein the glass article has a thickness of at most 3 mm.

18. The glass article of claim 1, wherein the glass article is configured for a use selected from a group consisting of a cover sheet, an entertainment electronics device cover sheet, a display device cover sheet, computer screen cover sheet, a measurement device screen cover sheet, a TV screen cover sheet, a mobile device cover sheet, mobile terminal device cover sheet, a mobile data processing device screen cover sheet, cell phone screen cover sheet, a mobile computer screen cover sheet, a palmtop screen cover sheet, a laptop screen cover sheet, a tablet computer screen cover sheet, a wearable device screen cover sheet, a watch face cover sheet, and a time measuring device screen cover sheet, a protective glazing, a protective glazing for a machine, glazing for a high-speed train, a safety glass cover sheet, an automotive glazing, a diving watches protective glazing, a submarines glazing, and a cover sheet for an explosion-proof device.

19. A lithium aluminum borosilicate glass, comprising, in wt %:

| | |
|---|---|
| SiO₂ | 57 to 69; |
| B₂O₃ | 0.5 to 7; |
| Al₂O₃ | 17 to 25; |
| Li₂O | 3 to 5.5; |
| Na₂O | 0.8 to 8; |

and
a total content of Al₂O₃ and SiO₂ between at least 75 and at most 92.

20. A method for producing a glass article, comprising exposing a glass sheet to an ion exchange in an exchange bath comprising between at least 20 wt % and up to 100 wt % of a sodium salt for a duration of at least 2 hours and not more than 24 hours, at a temperature between at least 380° C. and at most 440° C., wherein the sodium salt comprises sodium nitrate (NaNO₃) and potassium nitrate (KNO₃).
